(19) United States
(12) Patent Application Publication
(10) Pub. No.: US 2024/0331923 A1
(43) Pub. Date: Oct. 3, 2024

(54) COIL DEVICE

(71) Applicant: TDK CORPORATION, Tokyo (JP)

(72) Inventors: Hirofumi SASAKI, Tokyo (JP); Koji SHIMURA, Tokyo (JP); Kyosuke INUI, Tokyo (JP)

(73) Assignee: TDK CORPORATION, Tokyo (JP)

(21) Appl. No.: 18/616,818

(22) Filed: Mar. 26, 2024

(30) Foreign Application Priority Data
Mar. 30, 2023 (JP) 2023-056582

(51) Int. Cl. H01F 27/28

(52) U.S. Cl. CPC H01F 27/2823

(57) ABSTRACT

A coil device comprises a first magnetic material portion containing a magnetic material and having a plate-shaped portion and a protrusion, a metal wire having a winding portion including two or more layers of winding layers wound around the protrusion; and a second magnetic material portion containing a magnetic material and a resin, having a content ratio of the magnetic material smaller than that of the first magnetic material portion, and covering at least an outer peripheral side of the winding portion, wherein a set of wire cross sections is deformed with respect to a perfect circle such that a center-to-center distance of at least one set of adjacent wire cross sections is shorter than in case that the set of wire cross sections is a perfect circle, viewed in a predetermined cross section including a winding axis of the winding portion.

### BACKGROUND OF THE INVENTION

### 1. Technical Field

The present invention relates to a coil device used as an inductor element or the like.

### 2. Description of the Related Art

As a coil device, a combination of two types of core portions having different content ratios of resin and magnetic material and a winding portion has been proposed. In such a coil device, by using two types of core portions having different content ratios of resin and magnetic material, it is possible to relax stress and prevent occurrence of cracks.

In such a coil device, a magnetic material is disposed so as to cover the winding portion, which is advantageous from the viewpoint of improving inductance. However, in such a coil device, for example, when the number of windings increases, a space for disposing the wire becomes large, and a space for disposing the magnetic material becomes small, and the inductance may not be sufficiently improved, which is a problem.

### CITATION LIST

### Patent Literature

Patent Literature 1: JP 2017-199734 A

### BRIEF SUMMARY OF THE INVENTION

The present disclosure has been made in view of such circumstances, and provides a coil device capable of improving inductance.

According to an aspect of the present disclosure, there is provided a comprising:
a first magnetic material portion containing a magnetic material and having a plate-shaped portion and a protrusion protruding from the plate-shaped portion;
a metal wire having a winding portion including two or more layers of winding layers wound around the protrusion; and
a second magnetic material portion containing a magnetic material and a resin, having a content ratio of the magnetic material smaller than that of the first magnetic material portion, and covering at least an outer peripheral side of the winding portion,
wherein a set of wire cross sections is deformed with respect to a perfect circle such that a center-to-center distance of at least one set of adjacent wire cross sections is shorter than in case that the set of wire cross sections is a perfect circle, viewed in a predetermined cross section including a winding axis of the winding portion, in which wire cross sections that are cross sections of the metal wire are observed for the number of windings of the metal wire around the protrusion.

In the coil device according to the present disclosure, the wire cross section of the winding portion has at least one set of wire cross sections deformed so that the center-to-center distance is shorter than that in the case of a perfect circle. Since the wire cross section is deformed in this manner, the metal wire can be disposed more densely than in the case of a perfect circle, and more magnetic materials can be disposed around the winding portion, which is advantageous from the viewpoint of improving inductance.

Further, for example, at least one of the set of wire cross sections is directed to the first magnetic material portion.

In such a coil device, by forming the deformed wire cross section in the vicinity of the first magnetic material portion where the deformation force is relatively large in the cross section of the coil device, it is possible to avoid applying an excessive deformation force to the wire cross section at the time of manufacturing. Therefore, such a coil device has a good withstand voltage property.

Further, for example, the number of windings of the metal wire around the protrusion is 6 or more, and in the predetermined cross section, an average value of roundness represented by a value obtained by dividing a maximum diameter by a minimum diameter in first to third wire cross sections in order of being close to a corner portion formed between the plate-shaped portion and the protrusion is larger than an average value of the roundness in first to third wire cross sections in order of being distant from the corner portion.

In such a coil device, a greatly deformed wire cross section is formed in the vicinity of the corner portion where the deformation force becomes relatively large in the cross section of the coil device, and a wire cross section with less deformation is formed in a portion separated from the corner portion where the deformation force becomes relatively small. In such a coil device, the arrangement density of the wire cross section in the vicinity of the corner portion is increased to improve the inductance, and an excessive deformation force is avoided from being applied to the wire cross section at the time of manufacturing, thereby achieving a good withstand voltage property.

Further, for example, the predetermined cross sections are provided on one side and the other side of the protrusion.

In such a coil device, it is possible to improve inductance by disposing the metal wire densely over the entire winding portion and disposing more magnetic materials around the winding portion.

Further, for example, the number of windings of the metal wire around the protrusion is 9 or more, and
an average value of roundness represented by a value obtained by dividing a maximum diameter by a minimum diameter in the wire cross sections from a fourth wire cross section in order of being close to a corner portion formed between the plate-shaped portion and the protrusion to a fourth wire cross section in order of being distant from the corner portion is smaller than an average value of the roundness in the wire cross sections from a first wire cross section to a third wire cross section in order of being close to the corner portion, and is larger than an average value of the roundness in the wire cross sections from a first wire cross section to a third wire cross section in order of being distant from the corner portion.

In such a coil device, the deformation of the wire cross section corresponding to the difference in the deformation force acting at the time of manufacturing is generated with respect to the wire cross section disposed in each portion in the predetermined cross section of the coil device. In such a coil device, the arrangement density of the wire cross section is increased in the region close to the corner portion to improve the inductance, and the winding portion as a whole avoids application of an excessive deformation force to the wire cross section at the time of manufacturing, thereby achieving a good withstand voltage property.

Further, for example, the number of windings of the metal wire around the protrusion is 6 or more, and
an average value of roundness represented by a value obtained by dividing a maximum diameter by a minimum diameter in the wire cross sections from a first wire cross section to a third wire cross section in order of being close to a corner portion formed between the plate-shaped portion and the protrusion is 1.03 times or more an average value of the roundness in the wire cross sections from a first wire cross section to a third wire cross section in order of being distant from the corner portion.

In such a coil device, the difference in roundness indicating a deformation degree of the wire cross section is large between the vicinity of the corner portion where the deformation force becomes large and the portion separated from the corner portion where the deformation force becomes small in the cross section of the coil device. In such a coil device, the arrangement density of the wire cross section in the vicinity of the corner portion is increased to improve the inductance, and an excessive deformation force is avoided from being applied to the wire cross section at the time of manufacturing, thereby achieving a good withstand voltage property.

Further, for example, the number of windings of the metal wire around the protrusion is 6 or more, and
an average value of roundness represented by a value obtained by dividing a maximum diameter by a minimum diameter in the wire cross sections from a first wire cross section to a third wire cross section in order of being distant from a corner portion formed between the plate-shaped portion and the protrusion is 1.12 or less.

In such a coil device, by reducing the deformation degree of the wire cross section disposed at the position where the deformation force is relatively small, an excessive deformation force is avoided from being applied to the wire cross section disposed at the position where the deformation force is relatively large at the time of manufacturing, thereby achieving a good withstand voltage property.

### BRIEF DESCRIPTION OF THE DRAWINGS

FIG. 1 is a partially transparent perspective view of a coil device according to one embodiment of the present disclosure;

FIG. 2 is a cross-sectional view of the coil device illustrated in FIG. 1;

FIG. 3 is an enlarged cross-sectional view in which the periphery of a winding portion in a cross section illustrated in FIG. 2 is enlarged;

FIG. 4 is a conceptual diagram illustrating a method of measuring roundness of a wire cross section included in the cross section illustrated in FIG. 3; and

FIG. 5 is a graph illustrating a measurement result of roundness of a wire cross section in a coil device according to an example.

### DETAILED DESCRIPTION OF THE INVENTION

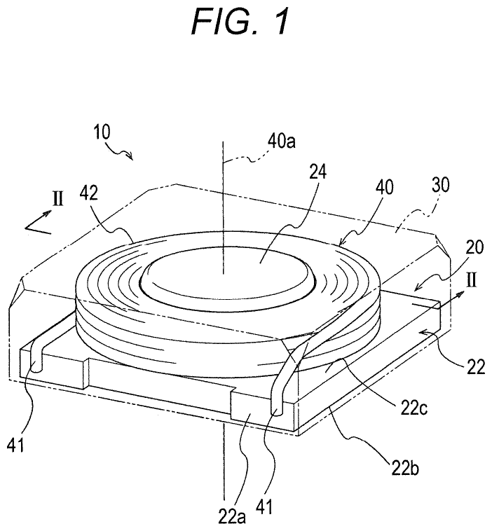

FIG. 1 is a partially transparent perspective view of a coil device 10 according to one embodiment of the present disclosure. As illustrated in FIG. 1, the coil device 10 includes a first magnetic material portion 20, a second magnetic material portion 30, and a metal wire 40. In addition, the coil device 10 includes a pair of terminal electrodes (not illustrated in FIG. 1) connected to the metal wire 40. In FIG. 1, in order to understand an internal structure of the coil device 10, the second magnetic material portion 30 is displayed as a virtual line in a see-through manner.

As illustrated in FIG. 1, the coil device 10 has a substantially rectangular parallelepiped outer shape, and the first magnetic material portion 20 is disposed near a bottom surface of the coil device 10. The first magnetic material portion 20 contains a magnetic material, and includes a plate-shaped portion 22 having a substantially rectangular tabular shape and a columnar protrusion 24 protruding upward from a central portion of the plate-shaped portion 22.

The first magnetic material portion 20 includes, for example, a sintered core made of a magnetic material not containing a resin, a core containing a resin and a magnetic material formed by compression molding or injection molding granules containing a magnetic material powder constituting the magnetic material and a resin as a binder, and the like. The magnetic material powder is not particularly limited, and for example, metal magnetic material powder such as Sendust (Fe—Si—Al; iron-silicon-aluminum), Fe—Si—Cr (iron-silicon-chromium), permalloy (Fe—Ni), carbonyl iron-based, carbonyl Ni-based, amorphous powder, and nanocrystal powder may be preferably used.

However, the magnetic material powder may be a ferrite magnetic material powder such as Mn—Zn or Ni—Cu—Zn. When the first magnetic material portion 20 contains a magnetic material and a resin, a binder resin contained in the first magnetic material portion 20 is not particularly limited, and examples thereof include an epoxy resin, a phenol resin, an acrylic resin, a polyester resin, polyimide, polyamideimide, a silicon resin, and a combination thereof.

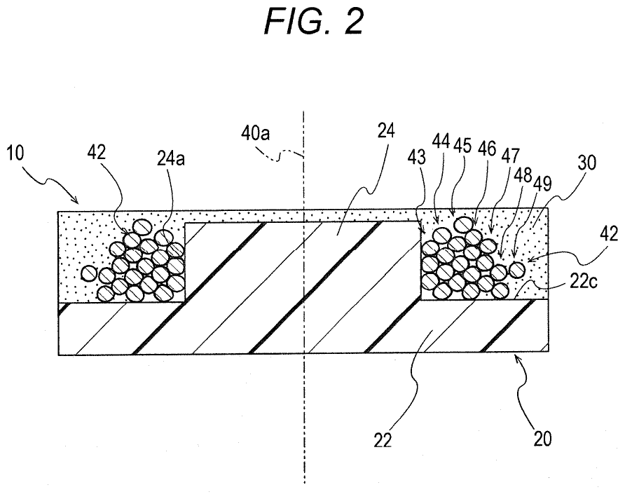

As illustrated in FIG. 2 which is a cross-sectional view, the first magnetic material portion 20 functions as a core in the coil device 10 together with the second magnetic material portion 30 to be described later. The plate-shaped portion 22 has a larger projected area than the protrusion 24 when viewed from above. A thickness of the plate-shaped portion 22 can be set to about 10 to 40% of the total thickness of the coil device 10, but is not particularly limited. The shape of the plate-shaped portion 22 is not limited only to the substantially rectangular tabular shape, and may be a shape other than the rectangular tabular shape, such as a polygonal plate shape, a circular plate shape, or an elliptical plate shape.

The protruding height of the protrusion 24 is also not particularly limited, but can be set to about 20 to 60% of the entire thickness of the coil device 10. The outer peripheral shape of the protrusion 24 illustrated in FIG. 1 is not limited to a circular shape, and may be a shape other than a circular shape, such as an elliptical shape or a polygonal shape, but is preferably a circular shape or an elliptical shape from the viewpoint of winding the metal wire 40 in close contact with the outer periphery of the protrusion 24.

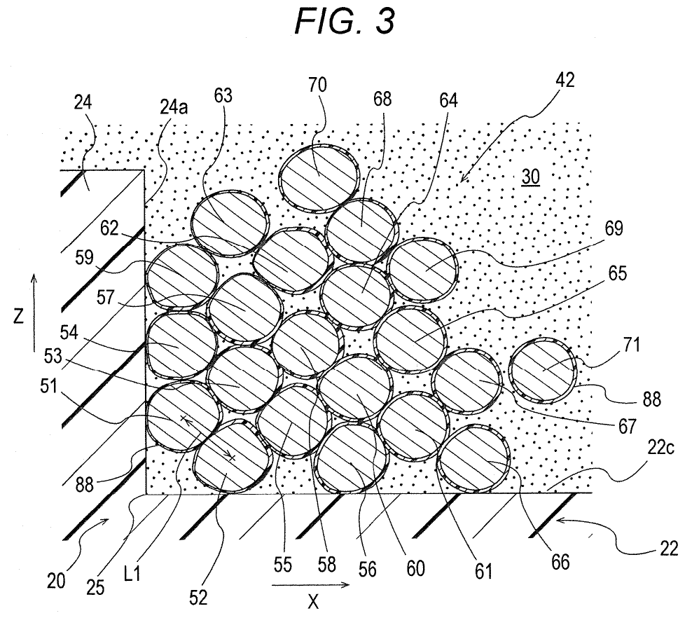

As illustrated in FIG. 1, the metal wire 40 includes a winding portion 42 that forms two or more winding layers around the protrusion 24, and a wire end portion 41 drawn out from the winding portion 42. As illustrated in FIG. 3 which is an enlarged view, a wire coating 88 which is an insulating coating is formed on the surface of the metal wire 40.

The metal wire 40 is made of, for example, Cu, Al, Fe, Ag, Au, phosphor bronze, or the like. Examples of the material of the wire coating 88 formed on the surface of the metal wire 40 include polyurethane, polyamideimide, polyimide, polyester, polyester-imide, polyester-nylon, and the like.

A part of the metal wire 40 is wound around the protrusion 24 to form the winding portion 42. FIG. 2 is a cross-sectional view taken along a predetermined cross section including a winding axis 40a of the winding portion 42, and in FIG. 3 which is a partially enlarged view thereof, wire cross sections 51 to 71 which are cross sections of the metal wire 40 are observed for the number of windings of the metal wire 40 around the protrusion 24. Although the number of windings of the metal wire 40 around the protrusion 24 in the coil device 10 illustrated in FIGS. 2 and 3 is 21, the number of windings of the winding portion 42 is not particularly limited. However, when the average value of the roundness in the wire cross sections 51 to 71 is calculated, the number of windings that enables the calculation of the roundness is provided. The winding portion 42 is disposed in a region defined by a substantially L-shaped wall formed by a plate-shaped portion upper surface 22c of the plate-shaped portion 22 and the protrusion side surface 24a of the protrusion 24. As illustrated in FIG. 2, the winding portion 42 forms two or more winding layers, and in the embodiment, the winding layers of a first winding layer 43, a second winding layer 44, a third winding layer 45, a fourth winding layer 46, a fifth winding layer 47, a sixth winding layer 48, and a seventh winding layer 49 are formed. The first winding layer 43 is pressed against the protrusion side surface 24a of the protrusion 24 and wound, and the second winding layer 44 is pressed against the first winding layer 43 on the inner peripheral side and wound. Similarly to the second winding layer 44, the third winding layer 45, the fourth winding layer 46, the fifth winding layer 47, and the sixth winding layer 48 are also pressed against the winding layer on the inner peripheral side and wound.

The winding portion 42 is preferably formed by winding the metal wire 40 around the winding portion 42 with a winding machine or the like from the viewpoint of bringing the winding portion 42 into close contact with the protrusion side surface 24a and increasing the winding density. However, the winding portion 42 may be formed of an air-core coil. The number of winding layers included in the winding portion 42 is also not particularly limited, and any two or more winding layers can be formed around the winding portion 42. In the winding portion 42, all the winding layers may be pressed against the inner winding layer and wound, or a part or all of the winding layers may be wound with a space from the winding layer on the inner peripheral side.

As illustrated in FIG. 2, the metal wire 40 is a round wire having a substantially circular wire cross section (see the wire cross section 51 to 71 illustrated in FIG. 3 and the like). The metal wire 40 is preferably a round wire from the viewpoint of introducing the magnetic material into some or all of inter-wire spaces, which are spaces between the wire cross sections 51 to 71.

As illustrated in FIG. 1, the metal wire 40 has a pair of wire end portions 41 drawn out from both ends of the winding portion 42, and each wire end portion 41 is connected to a terminal electrode portion (not illustrated) formed on a plate-shaped portion side surface 22a and a plate-shaped portion bottom surface 22b of the plate-shaped portion 22. The terminal electrode portion may be, for example, a metal terminal such as copper or a copper alloy bonded to the plate-shaped portion 22, a baked electrode containing silver, a silver alloy, or the like, or a metal film electrode formed by plating or the like.

As illustrated in FIG. 2, the second magnetic material portion 30 covers at least the outer peripheral side of the winding portion 42 and constitutes the core of the coil device 10 together with the first magnetic material portion 20. The second magnetic material portion 30 contains a magnetic material and a resin. The second magnetic material portion 30 contains a magnetic material similarly to the first magnetic material portion 20, but a content ratio of the magnetic material is smaller than that of the first magnetic material portion 20. Since the content ratio of the magnetic material is small, the second magnetic material portion 30 can be disposed around the winding portion 42 in a state of having fluidity at the time of manufacturing, whereby the second magnetic material portion 30 can be brought into close contact with the winding portion 42 from the outer peripheral side and the upper side without any space.

As the magnetic material included in the second magnetic material portion 30, metal magnetic material powder or ferrite magnetic material powder similar to those exemplified as the magnetic material powder included in the first magnetic material portion 20 can be used. Examples of the binder resin contained in the second magnetic material portion 30 include an epoxy resin, a phenol resin, an acrylic resin, a polyester resin, polyimide, polyamideimide, a silicon resin, and a combination thereof, as with the first magnetic material portion 20.

When the second magnetic material portion 30 is combined with the first magnetic material portion 20 having only one plate-shaped portion 22 as illustrated in FIGS. 1 and 2, the second magnetic material portion 30 is disposed not only on the outer peripheral side of the winding portion 42 but also on the upper side of the winding portion 42 and the upper side of the protrusion 24. However, when the first magnetic material portion has a drum core shape having a pair of plate-shaped portions sandwiching the protrusion, the second magnetic material portion may be disposed only in a region on the outer peripheral side of the winding portion 42 sandwiched in the vertical direction by the plate-shaped portions.

The second magnetic material portion 30 is manufactured by compression molding or the like. For example, the second magnetic material portion 30 is obtained by putting an intermediate product in which the winding portion 42 is formed by the metal wire 40 around the protrusion 24 of the first magnetic material portion 20 and a mixture of the magnetic material powder and the binder resin to be the material of the second magnetic material portion 30 into a cavity and compressing the whole.

The content ratio of the magnetic material in the second magnetic material portion 30 is preferably 50% or more from the viewpoint of improving inductance, and more preferably 70% or more. In addition, the magnetic material contained in the second magnetic material portion 30 may be composed of two or more types of magnetic material powder having different mean particle diameters. In such a second magnetic material portion 30, since the particle diameter distribution of the magnetic material powder has peaks and is distributed in a wide range, the magnetic material powder having a small particle size easily enters the inter-wire space.

FIG. 3 is an enlarged cross-sectional view illustrating a predetermined cross section including the winding axis 40a of the winding portion 42 illustrated in FIG. 2, and wire cross sections 51 to 71 which is a cross section of the metal wire 40 are observed. In FIG. 3, the wire cross sections 51 to 71, which are the cross sections of the metal wire 40, can be observed by the number corresponding to the number of windings (21 turns) of the metal wire 40 around the protrusion 24.

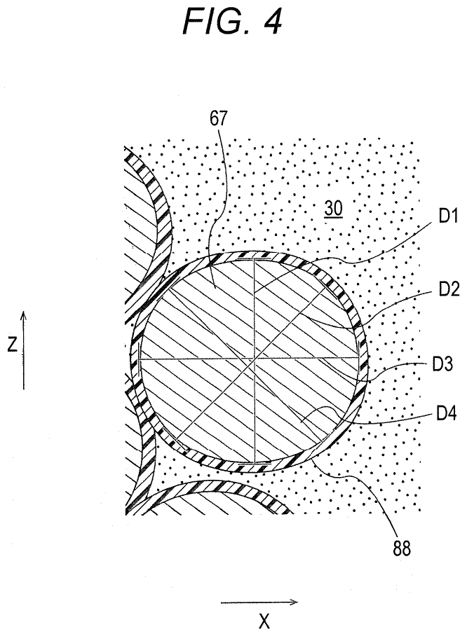

In the predetermined cross section illustrated in FIG. 3, a center-to-center distance L1 between at least one set of adjacent wire cross sections (for example, wire cross sections 51 and 52) is deformed with respect to a perfect circle such that the set of wire cross sections 51 and 52 is shorter than a case where the set of wire cross sections is a perfect circle. In the coil device 10, in addition to the wire cross sections 51 and 52, the wire cross sections 53 and 55, the wire cross sections 55 and 56, and the like also correspond to such a set of wire cross sections. The center of each of the wire cross section 51 to 71 is located at a position where a center line of each of the wire cross sections 51 to 71 in the direction (direction indicated by arrow Z in FIG. 4) of the winding axis 40a and a center line of each of the wire cross sections 51 to 71 in a direction (direction indicated by arrow X in FIG. 4) perpendicular to the winding axis 40a intersect each other.

In the coil device 10 having the wire cross sections 51, 52, 53, 55, and 56 deformed in this manner, the wire cross sections 51, 52, 53, 55, and 56 are crushed from a perfect circle and come close to a rectangular shape, so that a space between the wire cross sections 51, 52, 53, 55, and 56 is narrowed, and the metal wire 40 can be densely disposed. Therefore, in the coil device 10, more second magnetic material portions 30 can be formed around the metal wire 40, and the inductance can be improved. As illustrated in FIG. 3, it is also possible to dispose the magnetic material in the inter-wire spaces which are the spaces of the wire cross sections 51 to 71, but it is difficult to dispose the magnetic material in the inter-wire spaces at a higher density than the peripheral portion of the winding portion 42 where the second magnetic material portion 30 is disposed. Therefore, even in the coil device 10 in which the magnetic material is disposed in the inter-wire space, disposing the metal wire 40 densely leads to improvement in inductance.

Also, at least one of the set of wire cross sections 51 and 52 may face the first magnetic material portion 20. Since the wire cross sections 51 and 52 are adjacent to the first magnetic material portion 20 without sandwiching other wire cross sections therebetween, both face the first magnetic material portion 20. In such a coil device 10, by forming the deformed wire cross sections 51 and 52 in the vicinity of the first magnetic material portion 20 where the deformation force is relatively large in the cross section of the coil device 10, it is possible to avoid applying an excessive deformation force to the wire cross section 51 to 71 at the time of manufacturing. Therefore, in such a coil device 10, the insulation between the wire cross sections 51 to 71 by the resin, the wire coating 88, or the like is kept good, and the withstand voltage property is good.

As illustrated in FIG. 3, the coil device 10 in which the number of windings of the metal wire 40 around the protrusion 24 is 6 or more preferably has the following features. That is, in the predetermined cross section as illustrated in FIG. 3, an average value Vavg. of the roundness V in the first to third wire cross sections 51, 52, and 53 in order of being close to a corner portion 25 formed between the plate-shaped portion 22 and the protrusion 24 is larger than an average value Vavg. of the roundness V in the first to third wire cross sections 69, 70, and 71 in order of being distant from the corner portion 25. In FIG. 3, for the wire cross section 51 to 71, those closer to the corner portion 25 are denoted by a smaller number of reference numerals.

Here, the roundness V of each wire cross section 51 to 71 is defined by a value obtained by dividing the maximum diameter by the minimum diameter in the wire cross section 51 to 71. FIG. 4 is a conceptual diagram illustrating the definition of the roundness V of the wire cross section 67 using the wire cross section 51 to 71 as an example. As illustrated in FIG. 4, when the roundness V of the wire cross section 67 is calculated, first, a first diameter D1, a second diameter D2, a third diameter D3, and a fourth diameter D4 are calculated. The first diameter D1 is defined by a maximum width of the wire cross section 67 along the direction of the winding axis 40a indicated by the arrow Z. The second diameter D2 is defined by a maximum width of the wire cross section 67 along a direction rotated clockwise by 45 degrees from the direction of the winding axis 40a. The third diameter D3 is defined by a maximum width of the wire cross section 67 along a direction rotated clockwise by 90 degrees from the direction of the winding axis 40a. The fourth diameter D4 is defined by a maximum width of the wire cross section 67 along a direction rotated clockwise by 135 degrees from the direction of the winding axis 40a.

In the calculation of the roundness of the wire cross section 67, next, a value obtained by dividing the maximum diameter among the measured first to fourth diameters D1 to D4 by the minimum diameter among the measured first to fourth diameters D1 to D4 is calculated, and the value is set as the roundness V of the wire cross section 67. In the predetermined cross section, the direction of the first diameter D1 is parallel to the protrusion side surface 24a of the protrusion 24 in the first magnetic material portion 20, and the direction of the third diameter D3 is parallel to the plate-shaped portion upper surface 22c of the plate-shaped portion 22 in the first magnetic material portion 20.

With respect to the roundness V of each of the wire cross sections 51 to 71 calculated in this manner, in the coil device 10 illustrated in FIG. 3, the average value Vavg. of the roundness V in the wire cross sections 51, 52, and 53 close to the corner portion 25 is larger than the average value Vavg. of the roundness V in the wire cross sections 69, 70, and 71 distant from the corner portion 25. In such a coil device 10, greatly deformed wire cross sections 51, 52, and 53 are formed in the vicinity of the corner portion 25 where the deformation force becomes relatively large in the predetermined cross-section of the coil device 10, and less deformed wire cross sections 69, 70, and 71 are formed in portions separated from the corner portion 25 where the deformation force becomes relatively small. In such a coil device, the arrangement density of the wire cross sections 51, 52, and 53 in the vicinity of the corner portion 25 is increased to contribute to improvement of inductance, and application of an excessive deformation force to the wire cross section 51 to 71 at the time of manufacturing is avoided, thereby achieving a good withstand voltage property.

Furthermore, the coil device 10 in which the number of windings of the metal wire 40 around the protrusion 24 is 6 or more preferably has the following features. That is, in the predetermined cross section as illustrated in FIG. 3, the average value Vavg. of the roundness V in the first to third wire cross sections 51, 52, and 53 in order of being close to the corner portion 25 formed between the plate-shaped portion 22 and the protrusion 24 is 1.03 times or more the average value Vavg. of the roundness V in the first to third wire cross sections 69, 70, and 71 in order of being distant from the corner portion 25.

In such a coil device 10, the difference in the roundness V indicating a deformation degree of the wire cross sections 51 to 71 is large between the vicinity of the corner portion 25 where the deformation force increases in the predetermined cross section of the coil device 10 and the portion separated from the corner portion 25 where the deformation force decreases. In such a coil device 10, the arrangement density of the wire cross sections 51 to 71 in the vicinity of the corner portion 25 is effectively increased to improve the inductance, and an excessive deformation force is avoided from being applied to the wire cross sections 51 to 71 at the time of manufacturing, thereby achieving a good withstand voltage property.

Furthermore, the coil device 10 in which the number of windings of the metal wire 40 around the protrusion 24 is 6 or more preferably has the following features. That is, in the predetermined cross section as illustrated in FIG. 3, the average value Vavg. of the roundness V in the first to third wire cross sections 69, 70, and 71 in order of being distant from the corner portion 25 formed between the plate-shaped portion 22 and the protrusion 24 is 1.12 or less.

In such a coil device 10, by reducing the deformation degree of the wire cross sections 69, 70, and 71 disposed at positions where the deformation force is relatively small at the time of manufacturing, it is possible to avoid application of an excessive deformation force at the time of manufacturing to the other wire cross sections 51, 52, and 53 disposed at positions where the deformation force is relatively large at the time of manufacturing, thereby achieving a good withstand voltage property.

The coil device 10 in which the number of windings of the metal wire 40 around the protrusion 24 is 9 or more preferably has the following features. That is, in the predetermined cross section as illustrated in FIG. 3, the average value Vavg. of the roundness V in the wire cross sections 54 to 68 from the fourth cross section in order of being close to the corner portion 25 formed between the plate-shaped portion 22 and the protrusion 24 to the fourth cross section in order of being distant from the corner portion is smaller than the average value Vavg. of the roundness V in the first to third wire cross sections 51, 52, and 53 in order of being close to the corner portion 25, and is larger than the average value Vavg. of the roundness V in the first to third wire cross sections 69, 70, and 71 in order of being distant from the corner portion 25.

In such a coil device 10, the wire cross sections 51 to 71 are deformed corresponding to the difference in the deformation force acting at the time of manufacturing with respect to the wire cross section 51 to 71 disposed in each portion in the predetermined cross section of the coil device 10. In such a coil device 10, the arrangement density of the wire cross sections 51, 52, and 53 is increased in the region close to the corner portion 25 to improve the inductance, and the insulation between the wire cross sections 51 to 71 by the resin, the wire coating 88, and the like is maintained by avoiding application of an excessive deformation force to the wire cross sections 51 to 71 at the time of manufacturing the winding portion 42 as a whole, and a good withstand voltage property is exhibited.

In the coil device 10, it is also preferable to have predetermined cross sections illustrated in FIG. 3 at least on one side and the other side of the protrusion 24. In such a coil device 10, the metal wire 40 is densely disposed over the entire winding portion 42, and more magnetic materials are disposed around the winding portion 42, so that inductance can be improved.

As described above, in the coil device 10, since at least a part of each of the wire cross sections 51 to 71 is deformed, the metal wire 40 can be disposed more densely than in a case where each of the wire cross sections 51 to 71 is a perfect circle, and more magnetic materials can be disposed around the winding portion 42, which is advantageous from the viewpoint of improving the inductance.

Hereinafter, the coil device 10 will be described in more detail with reference to examples, but the coil device 10 is not limited to only examples.

In the example, after the coil device 10 as illustrated in FIGS. 1 to 3 was actually manufactured, the cross section illustrated in FIG. 3 was observed under an optical microscope, and the roundness V for each of the wire cross sections 51 to 71 was measured. The measurement procedure of the roundness V was performed by measuring the first to fourth diameters D1 to D4 as described with reference to FIG. 4. The results are illustrated in Table 1. The values of the first to fourth diameters D1 to D4, the maximum diameter, and the minimum diameter in Table 1 are relative values.

TABLE 1

| wire | first | second | third | fourth | | | | |
|---|---|---|---|---|---|---|---|---|
| cross | diameter | diameter | diameter | diameter | maximum | minimum | | |
| section | D1 | D2 | D3 | D4 | diameter | diameter | roundness V | Vavg. |
| 51 | 76.51 | 76.68 | 83.46 | 78.81 | 83.46 | 76.51 | 1.091 | 1.141 |
| 52 | 71.69 | 77.52 | 83.23 | 88.18 | 88.18 | 71.69 | 1.230 | |
| 53 | 71.85 | 74.11 | 78.03 | 79.24 | 79.24 | 71.85 | 1.103 | |
| 54 | 78.06 | 73.26 | 84.05 | 78.82 | 84.05 | 73.26 | 1.147 | 1.116 |
| 55 | 71.99 | 79.65 | 77.12 | 79.66 | 79.66 | 71.99 | 1.107 | |
| 56 | 71.15 | 72.83 | 79.52 | 79.67 | 79.67 | 71.15 | 1.120 | |
| 57 | 74.76 | 77.53 | 75.61 | 81.79 | 81.79 | 74.76 | 1.094 | |
| 58 | 76.27 | 70.79 | 73.26 | 75 | 76.27 | 70.79 | 1.077 | |
| 59 | 70.48 | 70.71 | 82.55 | 77.96 | 82.55 | 70.48 | 1.171 | |
| 60 | 70.69 | 71.99 | 76.28 | 80.51 | 80.51 | 70.69 | 1.139 | |
| 61 | 76.25 | 70.52 | 74.55 | 74.1 | 76.25 | 70.52 | 1.081 | |
| 62 | 74.02 | 71.13 | 74.71 | 85.63 | 85.63 | 71.13 | 1.204 | |
| 63 | 77.64 | 76.85 | 84.35 | 71.98 | 84.35 | 71.98 | 1.172 | |
| 64 | 77.12 | 73.61 | 69.43 | 73.8 | 77.12 | 69.43 | 1.111 | |
| 65 | 73.84 | 70.83 | 74.47 | 77.53 | 77.53 | 70.83 | 1.095 | |
| 66 | 78.39 | 71.46 | 70.7 | 74.13 | 78.39 | 70.7 | 1.109 | |
| 67 | 73.7 | 71.4 | 69.85 | 73.21 | 73.7 | 69.85 | 1.055 | |
| 68 | 76.27 | 72.31 | 71.99 | 72.64 | 76.27 | 71.99 | 1.059 | |
| 69 | 76.25 | 73.82 | 71.98 | 73.8 | 76.25 | 71.98 | 1.059 | 1.098 |
| 70 | 74.79 | 70.71 | 82.01 | 85.63 | 85.63 | 70.71 | 1.211 | |
| 71 | 71.46 | 69.94 | 69.86 | 70.29 | 71.46 | 69.86 | 1.023 | |

As illustrated in Table 1, the average value Vavg. of the roundness V in the first to third wire cross sections 51, 52, and 53 in order of being close to the corner portion 25 is 1.141, the average value Vavg. of the roundness V in the first to third wire cross sections 69, 70, and 71 in order of being distant from the corner portion 25 is 1.098, and the average value Vavg. of the roundness V in the wire cross sections 54 to 68 from the fourth cross section in order of being close to the corner portion 25 to the fourth cross section in order of being distant from the corner portion 25 is 1.116.

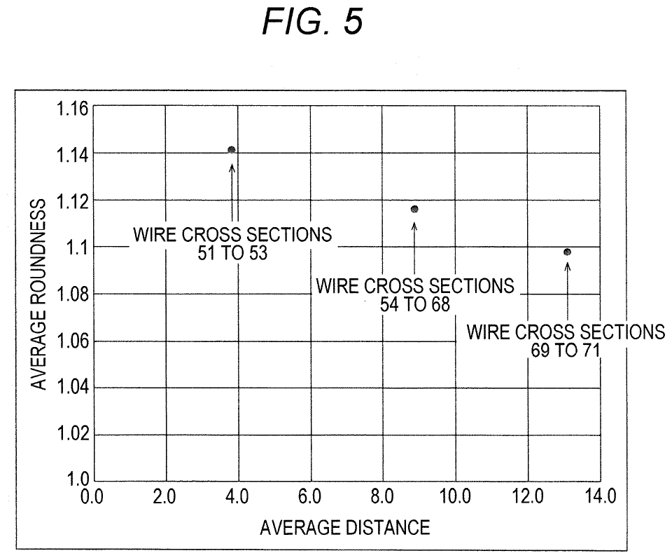

FIG. 5 is a graph in which the average value Vavg. of the roundness V of the wire cross sections 51, 52, and 53, the wire cross sections 54 to 68, and the wire cross sections 69, 70, and 71 is illustrated in a vertical axis and an average distance from the corner portion 25 to the center position of each of the wire cross sections 54 to 68, and the wire cross sections 69, 70, and 71 is illustrated. As illustrated in FIG. 5, as the distance from the corner portion 25 increases, the value of the average value Vavg. of the roundness V of the wire cross section 51 to 61 tends to decrease.

In addition, the center-to-center distance L1 of the set of wire cross sections 51 and 52 illustrated in FIG. 3 was 82.58, the thickness of the wire coating 88 on the center-to-center distance L1 was 12.0, and the sum of the radii (½ of the average value of the first to fourth diameters D1 to D4) when the wire cross sections 51 and 52 were perfect circles was 79.51. Therefore, it was confirmed that the set of wire cross sections 51 and 52 was deformed with respect to a perfect circle such that the center-to-center distance L1 of the set of wire cross sections 51 and 52 was shorter than 91.51 when the set of wire cross sections 51 and 52 was a perfect circle.

The present disclosure is not limited to the above-described embodiment and example, and various modifications can be made within the scope of the present disclosure.

For example, the coil device according to the present disclosure may have a first magnetic material portion having a drum core shape. In the coil device, the metal wires 40 may be wound around the protrusion 24, and the winding portion 42 may have wire cross sections having different cross-sectional areas and cross-sectional shapes.

### REFERENCE SIGNS LIST

10 coil device
20 first magnetic material portion
22 plate-shaped portion
22a plate-shaped portion side surface
22b plate-shaped portion bottom surface
22c plate-shaped portion upper surface
24 protrusion
24a protrusion side surface
25 corner portion
30 second magnetic material portion
40 metal wire
40a winding axis
41 wire end portion
42 winding portion
43 first winding layer
44 second winding layer
45 third winding layer
46 fourth winding layer
47 fifth winding layer
48 sixth winding layer
51 to 71 wire cross section
88 wire coating
L1 center-to-center distance
V roundness
Vavg. average value of roundness
D1 first diameter
D2 second diameter
D3 third diameter
D4 fourth diameter

What is claimed is:

1. A coil device comprising:
a first magnetic material portion containing a magnetic material and having a plate-shaped portion and a protrusion protruding from the plate-shaped portion;
a metal wire having a winding portion including two or more layers of winding layers wound around the protrusion; and
a second magnetic material portion containing a magnetic material and a resin, having a content ratio of the magnetic material smaller than that of the first magnetic material portion, and covering at least an outer peripheral side of the winding portion,
wherein a set of wire cross sections is deformed with respect to a perfect circle such that a center-to-center distance of at least one set of adjacent wire cross sections is shorter than in case that the set of wire cross sections is a perfect circle, viewed in a predetermined cross section including a winding axis of the winding portion, in which wire cross sections that are cross sections of the metal wire are observed for the number of windings of the metal wire around the protrusion.

2. The coil device according to claim 1, wherein at least one of the set of wire cross sections is directed to the first magnetic material portion.

3. The coil device according to claim 1, wherein the number of windings of the metal wire around the protrusion is 6 or more, and
in the predetermined cross section, an average value of roundness represented by a value obtained by dividing a maximum diameter by a minimum diameter in first to third wire cross sections in order of being close to a corner portion formed between the plate-shaped portion and the protrusion is larger than an average value of the roundness in first to third wire cross sections in order of being distant from the corner portion.

4. The coil device according to claim 1, wherein the predetermined cross sections are provided on one side and the other side of the protrusion.

5. The coil device according to claim 1,
wherein the number of windings of the metal wire around the protrusion is 9 or more, and
an average value of roundness represented by a value obtained by dividing a maximum diameter by a minimum diameter in the wire cross sections from a fourth wire cross section in order of being close to a corner portion formed between the plate-shaped portion and the protrusion to a fourth wire cross section in order of being distant from the corner portion is smaller than an average value of the roundness in the wire cross sections from a first wire cross section to a third wire cross section in order of being close to the corner portion, and is larger than an average value of the roundness in the wire cross sections from a first wire cross section to a third wire cross section in order of being distant from the corner portion.

6. The coil device according to claim 1,
wherein the number of windings of the metal wire around the protrusion is 6 or more, and
an average value of roundness represented by a value obtained by dividing a maximum diameter by a minimum diameter in the wire cross sections from a first wire cross section to a third wire cross section in order of being close to a corner portion formed between the plate-shaped portion and the protrusion is 1.03 times or more an average value of the roundness in the wire cross sections from a first wire cross section to a third wire cross section in order of being distant from the corner portion.

7. The coil device according to claim 1,
wherein the number of windings of the metal wire around the protrusion is 6 or more, and
an average value of roundness represented by a value obtained by dividing a maximum diameter by a minimum diameter in the wire cross sections from a first wire cross section to a third wire cross section in order of being distant from a corner portion formed between the plate-shaped portion and the protrusion is 1.12 or less.
